(19) United States
(12) Patent Application Publication
(10) Pub. No.: US 2022/0219256 A1
(43) Pub. Date: Jul. 14, 2022

(54) ORBITAL WELDING PURGE SYSTEMS

(71) Applicant: Clay Hubler, La Center, WA (US)

(72) Inventor: Clay Hubler, La Center, WA (US)

(21) Appl. No.: 17/145,160

(22) Filed: Jan. 8, 2021

(51) Int. Cl. B23K 9/32; B23K 9/028

(52) U.S. Cl. CPC B23K 9/325; B23K 2101/06; B23K 9/0286

(57) ABSTRACT

Orbital welding purge systems including a source, a supply line, an outlet, a flow control system, and a wireless control system. The source provides a supply of a purge gas. The supply line is in fluid communication with the source. The outlet is disposed on at an end of the supply line downstream of the source. The outlet is configured to direct the purge gas to a target weld area when the outlet is disposed proximate the target weld area. The flow control system is configured to selectively control the flow of the purge gas in the supply line from the source. The wireless control system is configured to control the flow control system. In some examples, the orbital welding purge system includes a differential pressure gauge. In some examples, the orbital welding purge system includes a plurality of additional supply lines.

### BACKGROUND

The present disclosure relates generally to orbital welding purge systems. In particular, remotely operable orbital welding purge systems are described.

Orbital welding is used to fusion weld high purity chemical and gas lines. High purity chemical and gas lines may be in the form of pipes or tubes. Orbital welding is a mechanized form of gas tungsten arc welding. For gas tungsten arc welding to produce clean and high quality welds, oxygen must be purged from the weld area.

Purging oxygen from the weld area is accomplished by purging the high purity chemical and gas line with high purity argon. It is critical that the argon flow within the line be controlled to provide a specific pressure of high purity argon at the area of the weld. Too little argon pressure results in a concave weld bead, which typically will not satisfy quality control requirements. Too much argon pressure will result in a convex weld bead, or in extreme cases a hole being blown in the weld.

A welder must precisely adjust the flow of argon to maintain a suitable pressure. Precisely adjusting the pressure of argon gas is accomplished by reading pressure in the high purity chemical and gas line and controlling the flow of argon as needed. Measuring the pressure of the argon is typically accomplished with a differential pressure gauge, such as a Magnehelic® gauge. Controlling the flow of argon is typically accomplished by adjusting needle valves controlling argon flow in supply lines and installing restrictors of varying sizes at the end of the line.

The needle valves are located in “purge manifolds” near a source of argon gas. Often the purge manifolds are located a great horizontal distance away from where the weld is taking place. Further, the purge manifolds may be at a different vertical distance, i.e., elevation, than the location of the weld, such as when the weld area requires scaffolding or mobile elevated work platforms to access.

The purge manifolds and the weld areas being spaced significant horizontal and vertical distances apart makes adjusting the needle valves and measuring the pressure in the line inconvenient and/or impractical for a single welder because he or she must repeatedly go back and forth between the target weld area and the purge manifold. Thus, two workers are often employed for the orbital welding process: one worker operates the welding machine and the other adjusts the flow of argon from the purge manifold according to the weld operator's instructions via telephone. Using two workers is costly and an inefficient use of labor.

It would be desirable to have an orbital welding purge system that did not require two workers to operate efficiently. It would further be desirable to have an orbital welding purge system where a single welder located at the target weld area could control the flow of argon from purge manifolds located away from the target weld area. Enabling the welder to control the flow of argon from remote purge manifolds wirelessly would be ideal. It would further be advantageous if the welder could control the flow of argon from remote purge manifolds using data communication over a network or the World Wide Web from a computing device.

Thus, there exists a need for orbital welding purge systems that improve upon and advance the design of known orbital welding purge systems. Examples of new and useful orbital welding purge systems relevant to the needs existing in the field are discussed below.

### SUMMARY

The present disclosure is directed to orbital welding purge systems including a source, a supply line, an outlet, a flow control system, and a wireless control system. The source provides a supply of a purge gas. The supply line is in fluid communication with the source. The outlet is disposed on at an end of the supply line downstream of the source. The outlet is configured to direct the purge gas to a target weld area when the outlet is disposed proximate the target weld area. The flow control system is configured to selectively control the flow of the purge gas in the supply line from the source. The wireless control system is configured to control the flow control system. In some examples, the orbital welding purge system includes a differential pressure gauge. In some examples, the orbital welding purge system includes a plurality of additional supply lines.

### BRIEF DESCRIPTION OF THE DRAWINGS

FIG. 1 is a schematic diagram of a first example of an orbital welding purge system including stepper motors.

FIG. 2 is a schematic diagram of a user interface on a smartphone for sending control inputs to a control module.

FIG. 3 is a schematic diagram of a second example of an orbital welding purge system including servo motors.

### DETAILED DESCRIPTION

The disclosed orbital welding purge systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various orbital welding purge systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

Orbital Welding Purge Systems

With reference to the figures, orbital welding purge systems will now be described. The orbital welding purge systems discussed herein function to purge oxygen from target weld areas with a purge gas.

The reader will appreciate from the figures and description below that the presently disclosed orbital welding purge systems address many of the shortcomings of conventional orbital welding purge systems. For example, the novel systems below enable a single welder to effectively and efficiently purge oxygen from high purity chemical and gas lines with high purity argon. The systems described below enable a welder to adjust the flow of argon to suitable levels to avoid concave weld beads from too little argon pressure and to avoid convex weld bead or holes in the weld from too much argon pressure.

The novel systems below make adjusting needle valves in a remote purge manifold and measuring the purge gas pressure at the target weld area convenient and practical for a single welder by eliminating the need for the welder to go back and forth between the target weld area and the purge manifold. Importantly, the novel systems discussed herein avoid the need to employ two workers for orbital welding. Unlike conventional systems, the systems described below do not require a worker separate from the worker operating the welding machine to be located at the purge manifold to adjust the flow of argon from the purge manifold according to the weld operator's instructions via telephone. As such, the novel systems discussed in this document are less costly and a more efficient use of labor than conventional orbital welding purge systems.

As will be described in more detail below, the novel systems herein desirably avoid requiring two workers to operate efficiently and enable a single welder to control the flow of argon from purge manifolds located away from the target weld area. The novel systems discussed in this document enable the welder to control the flow of argon from remote purge manifolds wirelessly. Further, in some examples the novel systems enable welders to control the flow of argon from remote purge manifolds using data communication over a network or the World Wide Web from a computing device.

Orbital Welding Purge System

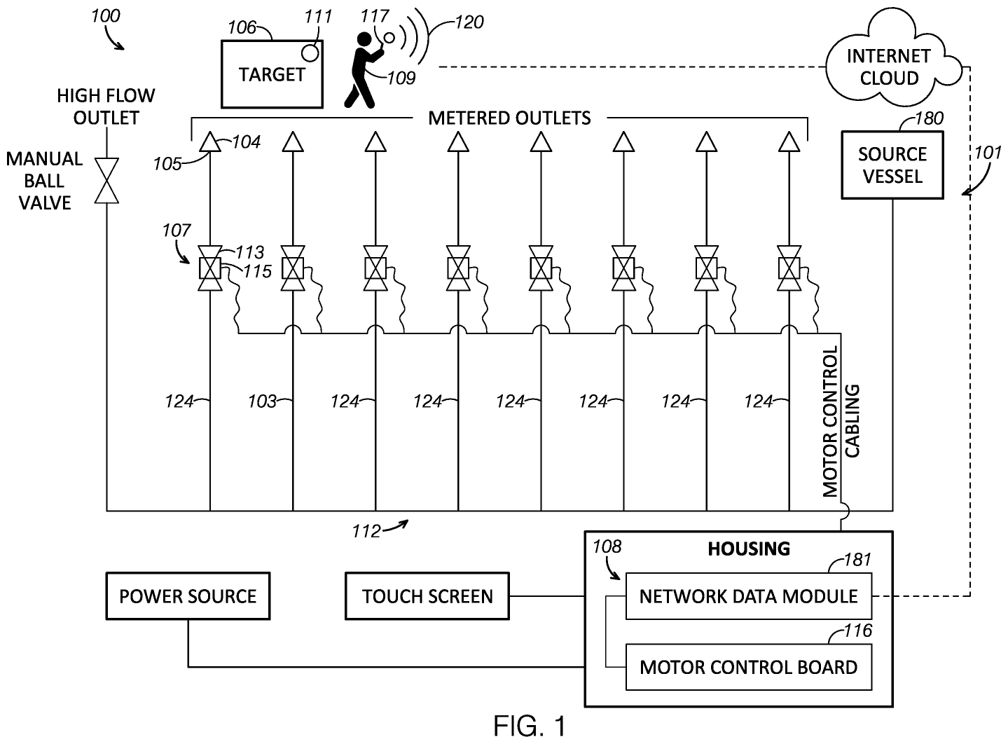

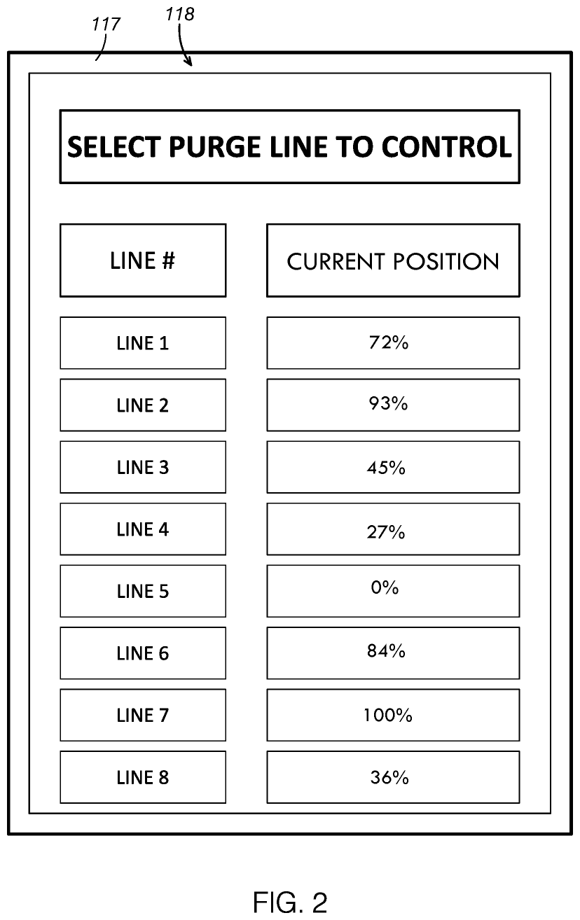

With reference to FIGS. 1 and 2, an orbital welding purge system 100 will now be described as a first example of an orbital welding purge system. As shown in FIG. 1, orbital welding purge system 100 includes a source 101, a supply line 103, an outlet 104, a flow control system 107, a wireless control system 108, a differential pressure gauge 111, and a plurality of additional supply lines 124. In other examples, the orbital welding purge system includes fewer components than depicted in the figures, such as not including additional supply lines and/or a differential pressure gauge. In certain examples, the orbital welding purge system includes additional or alternative components than depicted in the figures.

Source

As depicted in FIG. 1, source 101 provides a supply of purge gas to target weld area 106. With reference to FIG. 1, source 101 includes a source vessel 180 and a gas manifold 112. However, the source may include any combination of currently known or later developed types of gas containers or flow control equipment, such as vessels, tanks, manifolds, pipes, headers, and the like. The reader will appreciate that a variety of source types exist and could be used in place of the source shown in the figures. In addition to the types of sources existing currently, it is contemplated that the orbital welding purge systems described herein could incorporate new types of sources developed in the future.

The size of the source may be varied as needed for a given application. Source 101 and the other components of system 100 are depicted schematically in the figures and their depictions in the figures have no bearing on their actual size or relative size.

The number of sources in the orbital welding purge system may be selected to meet the needs of a given application. The reader should understand that the number of sources may be different in other examples than is shown in the figures. For instance, some orbital welding purge system examples include additional sources than described in the present example.

Purge Gas

The purge gas serves to remove oxygen from target weld area 106 to enable higher quality orbital welding at target weld area 106. In the present example, the purge gas is composed of argon. However, the purge gas may be composed of any currently known or later developed elements, molecules, or mixtures suitable for purging target weld areas of oxygen.

The purge gas may be any currently known or later developed type of purge gas. The reader will appreciate that a variety of purge gas types exist and could be used in place of argon. In addition to the types of purge gases existing currently, it is contemplated that the orbital welding purge systems described herein could incorporate new types of purge gases developed in the future.

Gas Manifold

The gas manifold may be any currently known or later developed type of gas manifold. The reader will appreciate that a variety of gas manifold types exist and could be used in the orbital welding purge systems discussed in this document. In addition to the types of gas manifolds existing currently, it is contemplated that the orbital welding purge systems described herein could incorporate new types of gas manifolds developed in the future.

Supply Line

The role of supply line 103 is to provide a conduit between source 101 and target weld area 106 to deliver purge gas from source 101 to target weld area 106. The reader can see in FIG. 1 that supply line 103 is in fluid communication with source 101.

The size of the supply line may be varied as needed for a given application. Supply line 103 and the other components of system 100 are depicted schematically in the figures and their depictions in the figures have no bearing on their actual size or relative size.

The supply line may be any currently known or later developed type of supply line. The reader will appreciate that a variety of supply line types exist and could be used in place of the supply line shown in the figures. In addition to the types of supply lines existing currently, it is contemplated that the orbital welding purge systems described herein could incorporate new types of supply lines developed in the future.

Plurality of Additional Supply Lines

Plurality of additional supply lines 124 serves to supply additional or alternative target weld areas with a supply of purge gas. Each supply line in plurality of additional supply lines 124 is in fluid communication with source 101. In some examples, the additional supply lines may be in fluid communication with an alternative source of purge gas rather than all supply lines being in fluid communication with the same source of purge gas.

The plurality of additional supply lines may be any currently known or later developed type of supply line. The reader will appreciate that a variety of supply line types exist and could be used in place of one or more of the plurality of additional supply lines shown in the figures. In addition to the types of supply lines existing currently, it is contemplated that the orbital welding purge systems described herein could incorporate new types of supply lines developed in the future.

The size of the plurality of additional supply lines may be varied as needed for a given application. The number of additional supply lines in the orbital welding purge system may be selected to meet the needs of a given application. The reader should understand that the number of supply lines may be different in other examples than is shown in the figures. For instance, some orbital welding purge system examples include additional or fewer supply lines than described in the present example.

Outlet

Outlet 104 is configured to direct purge gas to target weld area 106 when outlet 104 is disposed proximate target weld area 106. As depicted in FIG. 1, outlet 104 is disposed at an end 105 of supply line 103 downstream of source 101.

The outlet may be any currently known or later developed type of fluid outlet. The reader will appreciate that a variety of fluid outlet types exist and could be used in place of the outlet shown in the figures. In addition to the types of fluid outlets existing currently, it is contemplated that the orbital welding purge systems described herein could incorporate new types of fluid outlets developed in the future.

Flow Control System

With reference to FIG. 1, flow control system 107 is configured to selectively control the flow of purge gas in supply line 103 from source 101. Further, the reader can see in FIG. 1 that flow control system 107 is configured to selectively and independently control the flow of purge gas in each of plurality of additional supply lines 124.

As shown in FIG. 1, flow control system 107 is remote from target weld area 106. The reader can see in FIG. 1 that flow control system 107 is controlled by a user 109 located at target weld area 106 remote from flow control system 107. As depicted in FIG. 1, flow control system 107 is controlled by a single user 109 who is operating an orbital welder at target weld area 106. User 109 controls flow control system 107 via wireless control system 108 connected to flow control system 107 with motor control cabling in the present example.

With reference to FIG. 1, flow control system 107 includes a valve 113 and an actuator 115. However, the flow control system may be any currently known or later developed type of flow control system. The reader will appreciate that a variety of flow control system types exist and could be used in place of the flow control system shown in the figures. In addition to the types of flow control systems existing currently, it is contemplated that the orbital welding purge systems described herein could incorporate new types of flow control systems developed in the future.

The role of valve 113 is to selectively control the flow of purge gas through supply line 103. In the present example, valve 113 is a needle valve. However, the valve may be any currently known or later developed type of valve. The reader will appreciate that a variety of valve types exist and could be used in place of the valve shown in the figures. In addition to the types of valves existing currently, it is contemplated that the orbital welding purge systems described herein could incorporate new types of valves developed in the future.

Actuator

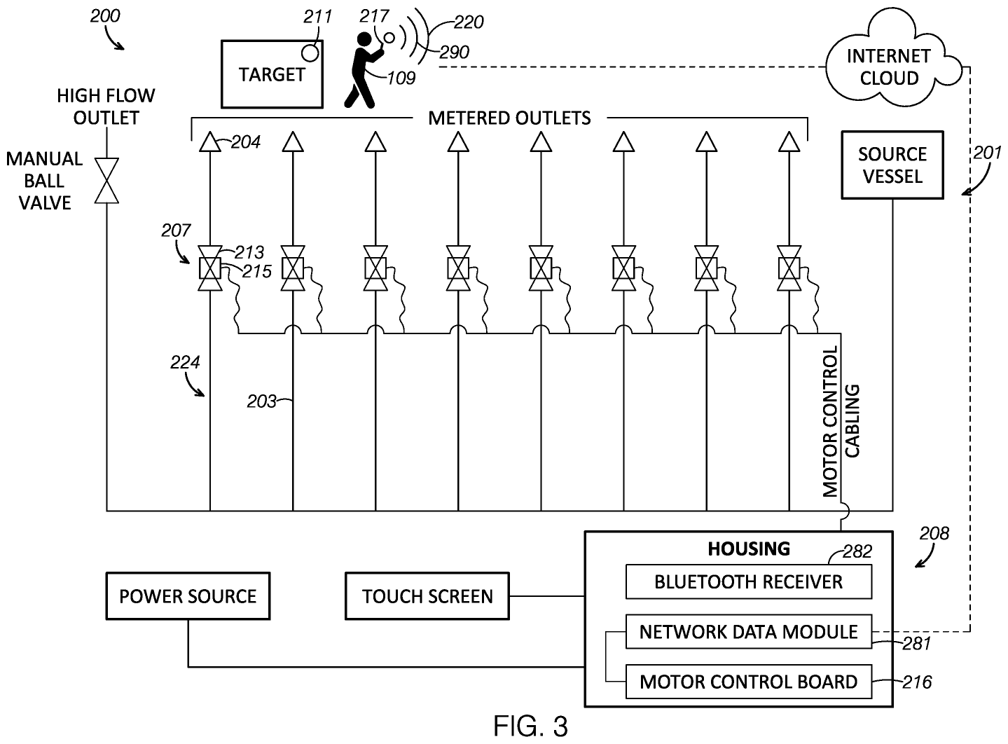

Actuator 115 serves to selectively operate valve 113. With reference to FIG. 1, actuator 115 is a stepper motor. As shown in FIG. 3 depicting another example of an orbital welding purge system 200, an alternative actuator, actuator 215, is a servo motor.

Actuator 115 includes a shaft coupled to a valve stem of valve 113 to enable direct drive actuation of valve 113. However, many coupling configurations are contemplated. In some examples, a custom coupler couples the actuator to the valve. The coupling between the actuator and the valve will typically be splined in some manner to allow the valve stem of the valve to move in and out as it is operated.

The actuator may be any currently known or later developed type of actuator. The reader will appreciate that a variety of actuator types exist and could be used in place of the actuator shown in the figures. In addition to the types of actuators existing currently, it is contemplated that the orbital welding purge systems described herein could incorporate new types of actuators developed in the future.

Orbital Welder

The orbital welder functions to fusion weld high purity chemical and gas lines. The size of the orbital welder may be varied as needed for a given application.

The orbital welder may be any currently known or later developed type of orbital welder. The reader will appreciate that a variety of orbital welder types exist and could be used in the present system. In addition to the types of orbital welders existing currently, it is contemplated that the orbital welding purge systems described herein could incorporate new types of orbital welders developed in the future.

Wireless Control System

The reader can see in FIG. 1 that wireless control system 108 is configured to control flow control system 107. As depicted in FIG. 1, wireless control system 108 is configured to selectively operate valve 113. With reference to FIG. 1, wireless control system 108 is configured to selectively activate actuator 115 to selectively operate valve 113. As shown in FIG. 1, in the present example wireless control system 108 is connected to flow control system 107 with motor control cabling.

As shown in FIG. 1, wireless control system 108 includes a control module 116, a network data module 181, a handheld device 117, an optional touchscreen, and a power source. The wireless control system may be incorporated into a wide variety of computing devices, including handheld devices, laptop computers, servers, or desktop computers. In the present example, control module 116 and network data module 181 are housed in a common housing.

The wireless control system may be any currently known or later developed type of wireless control system. The reader will appreciate that a variety of wireless control system types exist and could be used in place of the wireless control system shown in the figures. In addition to the types of wireless control systems existing currently, it is contemplated that the orbital welding purge systems described herein could incorporate new types of wireless control systems developed in the future.

Control Module

The role of control module 116 is to selectively activate actuator 115. The reader can see in FIG. 1 that control module 116 is electrically connected to actuator 115 and is configured to selectively activate actuator 115. As further shown in FIG. 1, control module 116 is in data communication with network data module 181.

The number of control modules in the orbital welding purge system may be selected to meet the needs of a given application. The reader should understand that the number of control modules may be different in other examples than is shown in the figures. For instance, some orbital welding purge system examples include additional or fewer control modules than described in the present example.

In the present example, control module 116 is a motor control board. However, the control module may be any currently known or later developed type of control module. The reader will appreciate that a variety of control module types exist and could be used in place of the control module shown in the figures. In addition to the types of control modules existing currently, it is contemplated that the orbital welding purge systems described herein could incorporate new types of control modules developed in the future.

Network Data Module

Network data module 181 shown in FIG. 1 functions to process data received from handheld device 117 and to relay processed instructions to control module 116. In some instances, network data module 181 receives data from handheld device 117 directly via wireless network protocol signals 120 sent by handheld device 117 and received at network data module 181. In other instances, network data module 181 receives data from handheld device from a local network or an external network, including the World Wide Web, via a wired or wireless data connection to the network. In such instances, handheld device 117 communicates data to the network and the network communicates the data to network data module 181.

Handheld Device

Handheld device 117 functions to communicate the control inputs from user 109 to control module 116 via network data module 181. As depicted in FIG. 1, handheld device 117 is in wireless data communication with network data module 181. The reader can see in FIGS. 1 and 2 that handheld device 117 is configured to communicate with control module 116 via network data module 181 using a wireless network protocol 120. As shown in FIGS. 1 and 2, handheld device 117 is configured to communicate the control inputs from user 109 to control module 116 network data module 181.

With reference to FIGS. 1 and 2, handheld device 117 includes a user interface 118 configured to receive control inputs from a user 109. In the present example, as depicted in FIGS. 1 and 2, handheld device 117 is a smartphone.

However, the handheld device may be any currently known or later developed type of handheld device. Suitable handheld devices include smartphones, tablet computers, remote controls, or other similar devices. The reader will appreciate that a variety of handheld device types exist and could be used in place of the handheld device shown in the figures. In addition to the types of handheld devices existing currently, it is contemplated that the orbital welding purge systems described herein could incorporate new types of handheld devices developed in the future.

User Interface

As shown in FIG. 2, user interface 118 is configured to receive control inputs from a user 119. In the simplified example shown in FIG. 2, user interface 118 displays the status of valves controlling the flow of purge gas in eight supply lines. In particular, user interface 118 displays the position of each valve in each supply line. The position of a valve is expressed as the percent each valve is open.

Clicking a given supply line indicator or a given valve percent open reading provides the user with an opportunity to change the position of the valve. That is, the user can send a command to increase or decrease the percent the valve is open. The percent open command can range between 100% open allowing maximum flow of purge gas or 100% close stopping the flow of purge gas.

The user interface may be any currently known or later developed type or style of user interface. The reader will appreciate that a variety of user interface types exist and could be used in place of the user interface shown in the figures. In addition to the types of user interfaces existing currently, it is contemplated that the orbital welding purge systems described herein could incorporate new types of user interfaces developed in the future.

Wireless Network Protocol

In the present example, wireless network protocol 120 uses the WiFi standard to communicate data between computing devices. However, the wireless network protocol may be any currently known or later developed type of wireless network protocol. The reader will appreciate that a variety of wireless network protocol types exist and could be used in the systems described herein. In addition to the types of wireless network protocols existing currently, it is contemplated that the orbital welding purge systems described herein could incorporate new types of wireless network protocols developed in the future.

Differential Pressure Gauge

Differential pressure gauge 111 shown in FIG. 1 is configured to detect the pressure of purge gas at target weld area 106. In the present example, the differential pressure gauge is a Magnehelic® gauge. However, the differential pressure gauge may be any currently known or later developed type of differential pressure gauge. The reader will appreciate that a variety of differential pressure gauge types exist and could be used in place of the differential pressure gauge shown in the figures. In addition to the types of differential pressure gauges existing currently, it is contemplated that the orbital welding purge systems described herein could incorporate new types of differential pressure gauges developed in the future.

### Additional Embodiments

With reference to FIG. 3, the discussion will now focus on an additional orbital welding purge system embodiment. The additional embodiment includes many similar or identical features to orbital welding purge system 100. Thus, for the sake of brevity, each feature of the additional embodiments below will not be redundantly explained. Rather, key distinctions between the additional embodiments and orbital welding purge system 100 will be described in detail and the reader should reference the discussion above for features substantially similar between the different orbital welding purge system examples.

### Second Embodiment

Turning attention to FIG. 3, a second example of an orbital welding purge system, orbital welding purge system 200, will now be described. As can be seen in FIG. 3, system 200 includes a source 201, a supply line 203, an outlet 204, a flow control system 207, a wireless control system 208, a differential pressure gauge 211, and a plurality of additional supply lines 224.

A distinction between orbital welding purge system 200 and orbital welding purge system 100 is that handheld device 217 is configured to communicate with control module 216 via a frequency hopping spread spectrum radio transmission 290 in addition to a wireless network data protocol 220 like WiFi. In the present example, the frequency hopping spread spectrum radio transmission 290 utilizes a Bluetooth™ protocol, but any form of frequency hopping spread spectrum radio transmission may be used.

As shown in FIG. 3, wireless control system 208 includes a control module 216, a network data module 281, a frequency hopping spread spectrum radio transmission receiver 282, an optional touch screen, and a power source. In the present example, receiver 282 is a Bluetooth® receiver. However, any receiver configured to receive and process frequency hopping spread spectrum radio transmissions may be used.

Flow control system 207 presents another distinction between systems 100 and 200. In flow control system 207, actuator 215 is a servo motor rather than a stepper motor like actuator 115 in flow control system 107.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An orbital welding purge system comprising:
a source of a purge gas;
a supply line in fluid communication with the source;
an outlet disposed on at an end of the supply line downstream of the source, the outlet configured to direct the purge gas to a target weld area when the outlet is disposed proximate the target weld area;
a flow control system configured to selectively control the flow of the purge gas in the supply line from the source; and
a wireless control system configured to control the flow control system.

2. The orbital welding purge system of claim 1, wherein the flow control system is remote from the target weld area.

3. The orbital welding purge system of claim 18, wherein the flow control system is controlled by a user located at the target weld area remote from the flow control system.

4. The orbital welding purge system of claim 18, wherein the flow control system is controlled by a single user who is operating an orbital welder at the target weld area.

5. The orbital welding purge system of claim 1, wherein the purge gas is argon.

6. The orbital welding purge system of claim 1, further comprising a differential pressure gauge configured to detect the pressure of the purge gas at the target weld area.

7. The orbital welding purge system of claim 1, wherein the source is a gas manifold.

8. The orbital welding purge system of claim 1, wherein the flow control system includes a valve.

9. The orbital welding purge system of claim 8, wherein the wireless control system is configured to selectively operate the valve.

10. The orbital welding purge system of claim 8, wherein the valve is a needle valve.

11. The orbital welding purge system of claim 10, wherein the flow control system includes an actuator operable to selectively operate the needle valve.

12. The orbital welding purge system of claim 11, wherein the wireless control system is configured to selectively activate the actuator to selectively operate the needle valve.

13. The orbital welding purge system of claim 12, wherein the wireless control system includes:
a control module electrically connected to the actuator and configured to selectively activate the actuator;
a handheld device in wireless data communication with the control module.

14. The orbital welding purge system of claim 13, wherein:
the handheld device includes a user interface configured to receive control inputs from a user; and
the handheld device is configured to communicate the control inputs from the user to the control module.

15. The orbital welding purge system of claim 14, wherein the handheld device is configured to communicate with the control module via a wireless network protocol.

16. The orbital welding purge system of claim 14, wherein the handheld device is configured to communicate with the control module via frequency hopping spread spectrum radio transmission.

17. The orbital welding purge system of claim 16, wherein the handheld device is a smartphone.

18. The orbital welding purge system of claim 12, wherein the actuator is a stepper motor.

19. The orbital welding purge system of claim 12, wherein the actuator is a servo motor.

20. The orbital welding purge system of claim 1, wherein:
the orbital welding purge system further comprises a plurality of additional supply lines in fluid communication with the source; and
the flow control system is configured to selectively and independently control the flow of the purge gas in each of the plurality of additional supply lines.
